(19) United States
(12) Patent Application Publication
(10) Pub. No.: US 2026/0236608 A1
(43) Pub. Date: Aug. 13, 2026

(54) CRYPTOGRAPHIC DERIVATIVE DATA PROVENANCE ENFORCEMENT

(71) Applicant: Truebit Co., Buffalo Grove, IL (US)

(72) Inventor: Jason Richmond Teutsch, Buffalo Grove, IL (US)

(73) Assignee: Truebit Co., Buffalo Grove, IL (US)

(21) Appl. No.: 19/534,373

(22) Filed: Feb. 9, 2026

Related U.S. Application Data
(60) Provisional application No. 63/756,554, filed on Feb. 10, 2025.

(51) Int. Cl. G06F 21/62; G06F 21/60; H04L 9/32

(52) U.S. Cl. CPC G06F 21/6245; G06F 21/602; H04L 9/3234

(57) ABSTRACT

A system includes a network of processing nodes. The first processing node may receive, at a cryptographically-secure processing zone, base data from a second processing node in the network. The first node may cause generation of a provenance token indicating receipt of the base data from the second node. The first node may process the base data to generate derivative data without transfer of the base data out of the cryptographically-secure processing zone in an unencrypted form.

### PRIORITY

This application claims priority to U.S. Provisional Patent Application No. 63/756,554 filed Feb. 10, 2025, titled CRYPTOGRAPHIC DERIVATIVE DATA PROVENCE ENFORCEMENT, which is incorporated by reference in its entirety.

### TECHNICAL FIELD

This disclosure relates to cryptographic enforcement of data provenance.

### BACKGROUND

In recent years, demand for broad-ranging access to data has increased due to the need to train machine-learned models. This has driven the creation of data sets of massive size to support such training. Data from various sources is used and datasets may have mixed data origins. Technologies to support the composition, management, and distribution of such training data may continue to drive adoption of machine-learning training systems.

### BRIEF DESCRIPTION OF THE DRAWINGS

FIG. 1 shows an example data-share tracking environment.

FIG. 2A shows example node verification logic.

FIG. 2B shows example zone processing logic.

FIG. 3 shows an example execution system.

FIG. 4 shows an illustrative example collection of relevant inferences for a blockbuster.

### DETAILED DESCRIPTION

In various contexts, base data (e.g., data, executable code, machine learned models, model outputs, expressive data (such as media: books, essays, television, music, movies, and/or other expressive data), nanomaterial development, semiconductor material development chemical formulae, protein structures, pharmaceutical candidate substances, and/or other data) may be desirable for the generation of derivative data, e.g., generated using the base data as an input, such as a training input. However, in various scenarios, base data owners/curators may be disinterested in providing their base data for use in the generation of derivative data because of the lack of traceability of base data use from derivate data.

As an example illustration, an owner of a copyright for a book may be disinterested in providing the book as a part of a training routine for a generative AI model because the derivative data in this scenario (i.e., generative AI model) is of a nature that its training dependence on the book is unlikely to be immediately evident from the model itself. Thus, the book owner may have limited ability to determine whether the book was used in training and lack indication as to whether the book was received/ingested for model training.

According to conventional wisdom, the base data owner may enter into a contractual agreement, including large scale uniform contractual agreement, such as “sync” license agreements for the creation of derivative works and/or compulsory licensing in copyright, to allow the use of base data in the generation of the derivative data. However, as recognized herein, a contractual agreement may provide obligations that may be useful to the base data owner, but may not necessarily facilitate tracking and/or provide the indications of when base data is used. For situations where derivative data itself is used as a later input to another tier of derivative data, contractual agreement may also fail to facilitate tracking across such multi-generational creation of derivative data.

As recognized herein, a technological trustless tracking system may be implemented to track derivation across multi-generational derivative data tracking and may be particularly well-suited for tracking blockbuster scenarios, e.g., for input contributions to a singular or small number of high value outputs based on a comparatively large number of inputs that may have been incorporated across multiple derivation generations. For example, in the context of pharmaceutical candidate selection, multiple generations of machine-learned models (e.g., trained on each other's output) may be used to arrive a formulae for a small number of drugs for which high revenues are obtained. As recognized herein, a trustless tracking system may be used to ensure that upstream contributors have their inputs tracked through to the blockbuster outputs. Thus, sharing and provision of such models may freely occur (however such sharing may often be subject to other IP licensing agreements). Moreover, such technological trustless tracking systems may be readily combined with contractual obligations to provide multiple layers of protection for providers of base data.

According to conventional wisdom, contractual agreements may be used to control data disposition after sharing. For example, when data is shared for the training of machine-learned models, a receiver of shared data may be constrained to use/handle the data in accordance with contractual terms. As recognized herein, contractual obligations, though effective in many circumstances, may not themselves facilitate control or enforcement of data handling.

As recognized herein, a technological data handling enforcement scheme may be used to provide usage and access controls for base data entrusted to a computing node. Technological data handling enforcement may ensure that entrusted data is not shared, used, or accessed on disallowed terms. For example, re-sharing of base data may be disallowed and/or allowed only to nodes complying with the technical enforcement terms in effect when the base data was first shared. As an example, the base data itself may be inaccessible in unencrypted forms, e.g., to prevent review/analysis of the base data itself. In the example, outputs (e.g., if the base data is a machine learned model) from the base data may be viewable/accessible for processing and/or generating derivative data. As will be discussed below, such enforcement may be based on cryptographically-secured processing zone. The cryptographically-secured processing zone may have defined rules for input and removal of data from the zone, e.g., a defined listing of allowed operations for putting data into the zone, manipulating data inside the zone, and/or removing data for use outside the zone. The enforcement scheme may, at least in some cases, further implement transcripts, whether on- or off-ledger, as certification that a particular node has properly setup a cryptographically-secured processing zone.

In the techniques and architectures described herein, nodes within a multiple-node network receive and process base data to generate derivative data. The nodes within the network generate provenance tokens in response to reception of base data, the provenance tokens identifying from where the base data was received. Thus, the provenance tokens provide attribution for the base data inputs that were used to generate the derivative data. The base data inputs themselves may each be either original or derivative data. Thus, the provenance tokens generated by a particular node may extend existing chains of provenance back to a data origin for each base data input received.

To be an allowed recipient of base data, the nodes may be required to setup one or more cryptographically-secured processing zones. The base data may be received within the zone such that the receiving node never has possession of the base data outside of the enforcement provided the cryptographically-secured processing zone in which base data was received. Thus, the node furnishing base data may have confidence that the proper set of enforcement rules are in effect at the time the base data is furnished.

In various implementations, the cryptographically-secured processing zones may be implemented using various hardware and/or software to cryptographically-secure both memory and processing operations. As an example, a secure enclave may be used to implement a cryptographically-secured processing zone. A secure enclave may provide protection for defined memory locations and ensure that processing is routed through trusted hardware (while under encryption) to avoid allowing processing on/access to base data on other than the allowed processing terms.

Additionally or alternatively, various other trusted computing environments (TEEs) may be used to implement cryptographically-secured processing zones. For example, cloud-based solutions, such as Amazon Web Services® Nitro enclaves, and/or Google Cloud® confidential computing solutions may be used. Local hardware-based solutions may be used such as Advanced Mirco Devices® (AMD), Advanced RISC Machines® (ARM) and/or Intel® based TEE solutions.

The cryptographically-secured processing zones may allow processing, such as machine learning training and/or output generation, but may disallow other processing and/or access. In various implementations, the cryptographically-secured processing zones may disallow transfer of base data out of the zone, e.g., for unencrypted use and/or review. This may prevent use of shared base data for purposes other than the generation of derivative data. This may improve the security of the system reducing the leakage of data relative to conventional systems.

In some implementations, processing derivative data may be constrained by the cryptographically-secured processing zones. For example, access to derivative data machine learning models may be prevented by the cryptographically-secured processing zones. For example, the output of such models may be exported out of the zone, while the models (even for the node that created the derivative data) may be constrained by the zone. This may further drive re-sharing of models since extracting value from a model requires in-zone use of the model. Relatively more use may occur with relatively more re-sharing. This may facilitate the creation of larger and more complex dependency trees made up of the provenance chains represented in the provenance tokens.

In various implementations, nodes may establish cryptographically-secured processing zones through compliant execution of computer code that performs the setup. To certify that a particular node has properly established a cryptographically-secured processing zone, the node may execute the setup code and generate a transcript that captures the details of the execution. Methods and architectures for transcript generation to certify valid execution of code, such as those described in WIPO International PCT Patent Application No. PCT/US2024/052816, filed Oct. 24, 2024, and titled Integrity Systems for Verifiable Code Execution, which is incorporated in its entirety herein, may be used. Therein, in various described implementations, a code execution protocol may include execution of the code or application programming interface (API) call by a solver, hub, or node that produces a solver output (e.g., an execution record for the code or result of an API call). The operation may include a definitive timestamp. The solver output may be compared to one or more verifier outputs produced by verifiers purporting to execute identical code. When the outputs match, the match may provide evidence that the code was executed accurately and with fidelity by both solver and verifier(s). Mismatches may provide evidence of inaccurate and/or low-fidelity execution of the code by one or more of the parties. Further analysis, initiated as result of the mismatch, may provide the origin of the mismatch to assist in the identification of error/inaccuracies in the execution. In some cases, the solver and/or verifiers may execute the code in a contention-based protocol where the solver and/or verifiers may receive a set of tokens for accurate execution. Additionally or alternatively, solver and/or verifiers may surrender a counter-set of tokens for inaccurate, incomplete, and/or otherwise low-fidelity execution. The record, e.g., recorded as a ‘transcript’ may be later referenced as evidence that the code was executed as recorded and/or that the solver and/or verifier performed various actions in the proper order with the correct timing. For example, the transcript may include indications that the solver committed to a solution and/or revealed a solution in a proper order and/or with the proper timing. The transcript may be recorded in various environments included ‘off-chain’ environments as discussed below.

Thus, individual nodes may provide evidence (e.g., in the form of a transcript and/or other execution record) that the node has a properly established cryptographically-secured processing zone at which it may receive base data.

Tokens may be used for establishing provenance chains for base data. Tracking, such as that used in cryptocurrency to track a coin from mining to current ownership, may be used. Thus, a chain may be used to show previous base data input generations back to a tracking origin.

In some implementations, such verifiable code execution may be used to enforce rules regarding attribution and notification, or economics in accord with the tracked provenance chains. When revenue is generated (or generated above a predefined threshold) notifications may be triggered. Once triggered, a predefined protocol for execution of the notifications may be run as a “task” in accord with the verifiable code execution schemes discussed above. Thus, a transcript establishing proper notification (and/or establishing automated code to perform such notification once triggers are met) may be generated such that nodes sharing base data may have confidence proper notification has occurred (or will occur when proper conditions are met).

Additionally or alternatively, in at least some cases, ownership may be similarly tracked for data elements. For example, for a particular model (e.g., an individual quanta of base data) ownership may be held via token (e.g., such as a fungible or non-fungible token). A single token may represent a basket of one or more models and/or assets, where the model/asset ownership within the basket may be fractional and/or whole. Thus, when compensation is awarded based on provenance chains and the relevant base data is within the chain of compensation, the award may be directed in accord with the token indicating ownership of the base data. Thus, base data ownership may be tracked separately from data provenance. Data provenance can be used to determine what inputs were used to generate particular data, while data ownership may be used to determine who should receive compensation due as a result of provenance.

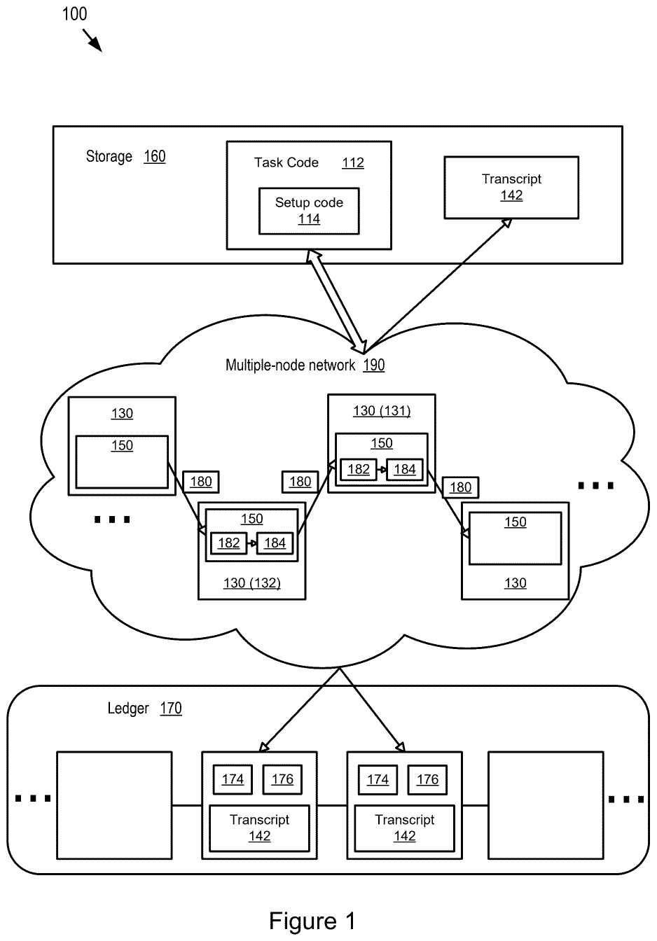

FIG. 1 shows an example data-share tracking environment (DTE) 100. In the example DTE 100, the multiple-node network 190 may include the nodes 130 (e.g., processing nodes) that may generate base data 182 and/or may receive and process base data 182 to generate derivative data 184. In the example DTE 100, the data 180 shared from one node 130 to another node 130 may be either base data 182 or derivative data 184 depending on the relationship with the nodes 130.

To receive the base data 182, the nodes 130 may set up the one or more cryptographically-secured processing zones 150. In the example DTE 100, the executable task code 112 may be stored in storage 160 and may be distributed to the nodes 130. The storage 160 may be off-chain storage. The executable task code 112 may include the setup code 114 to set up the one or more cryptographically-secured processing zones 150 that may have defined rules for input and removal of data from the zone. In some implementations, the executable task code 112, including the setup code 114, may be distributed to the nodes 130 via atomic broadcast distribution and/or non-atomic broadcast distribution. In some implementations, the task code 112 may be distributed to the nodes 130 via peer-to-peer distribution.

The nodes 130 may execute the setup code 114 and generate an execution transcript 142 that captures the details of the execution. The execution transcript 142 may be on-ledger (as shown the transcript 142 recorded on the distributed ledger 170), and/or may be stored off-ledger (as shown the transcript 142 stored in the storage 160).

The base data 182 may be received within the cryptographically-secured processing zones 150 such that the receiving node never has possession of the base data originated outside the cryptographically-secured processing zones 150 in which base data 182 was received. In some implementations, the cryptographically-secure processing zone 150 may include a secure enclave. In some implementations, the cryptographically-secure processing zone 150 may bar unencrypted read operations of the content.

In some implementations, the cryptographically-secure processing zone 150 may include a memory space protected via data-encryption. The memory space of the cryptographically-secure processing zone 150 protected via data-encryption may include specific rules for compliant allowed inputs to and allowed outputs from the memory space. For example, the specific rules for compliant allowed inputs to and allowed outputs from the memory space may include: preventing access to an unencrypted forms of a machine-learned model regardless of whether the machine-learned model includes base data 182 or derivative data 184; allowing access to an unencrypted form of the derivative data 184 including a machine-learned model output; and/or preventing access to an unencrypted form of the base data including a machine-learned model output.

In the example DTE 100, one of the nodes 130, i.e., a first processing node 131, may receive, at the cryptographically-secure processing zone 150, the base data 182 from another node 130, i.e., a second node 132, within the network 190 of the nodes 130. The nodes 130, including the first processing node 131 and/or the second node 132, may include a memory including the cryptographically-secure processing zone 150 and zone processing circuitry. The zone processing circuitry of the first processing node 131 may receive, at the cryptographically-secure processing zone 150, the base data 182 from at least the second node 132 within the network 190, and cause generation of a provenance token 174 indicating the receipt of the base data 182 from at least the second node 132. The provenance token 174 may be recorded on the distributed ledger 170.

In some implementations, the zone processing circuitry of the first processing node 131 may process, without transferring the base data 182 out of the cryptographically-secure processing zone 150 in an unencrypted form, at least the base data 182 to generate derivative data 184.

The base data 182 may be further associated with an ownership token 176 indicating ownership of the base data by one or more entities. The ownership token 176 may be recorded on the distributed ledger 170. In some implementations, the ownership token 176 identifying the ownership may be different/separate from the provenance token 174. Additionally or alternatively, the ownership token 176 may be combined with the provenance token 174.

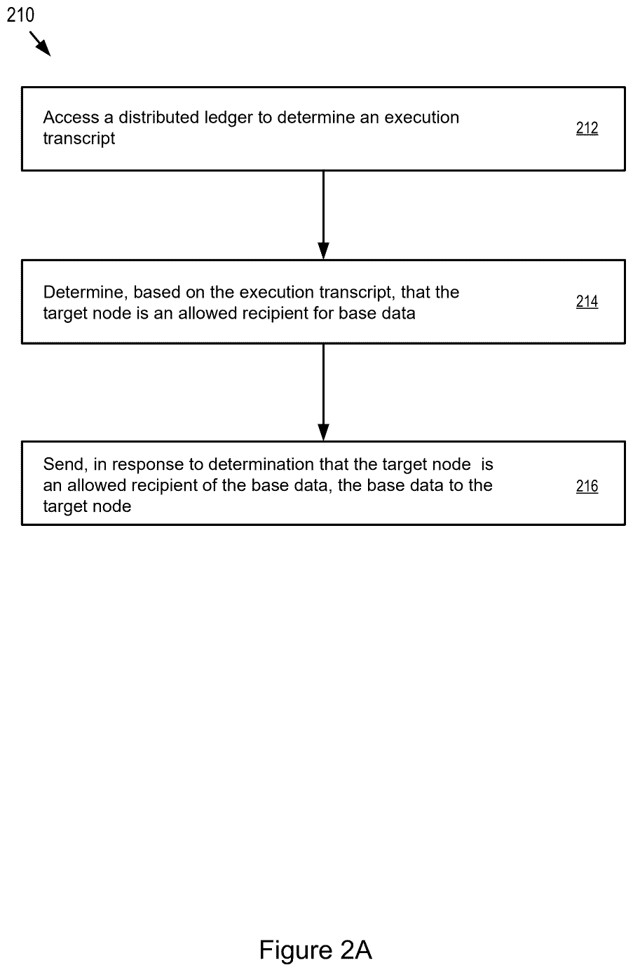

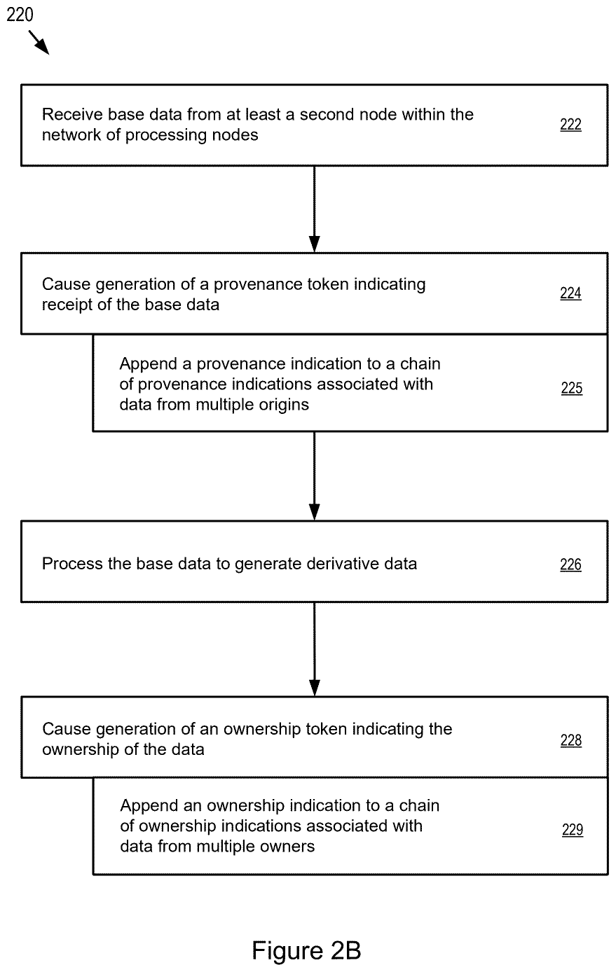

Referring now to FIG. 2A while continuing to refer to FIG. 1, node verification logic 210 is shown. The node verification logic 210 may execute on circuitry such as node circuitry present on one or more processing nodes 130 (e.g., the second node 132 configured to send the base data 182 to the first processing node 131). In some implementations, the node verification logic 210 may execute the operations associated with verification of the node 130 to receive the base data 182, i.e., the first node 131. The first node 131 may also be referred to as a target node.

The node verification logic 210 may access the distributed ledger 170 to determine an execution transcript 142 (212). The execution transcript 142 may indicate that the target node 131 executed a defined protocol (e.g., according to the setup code 114) without deviation from the defined protocol such that execution of the defined protocol establishes a cryptographically-secure processing zone 150 on the target node 131. The node verification logic 210 may determine, based on the execution transcript 142, that the target node 131 is an allowed recipient for the base data 182 within the cryptographically-secure processing zone 150 on the target node 131 (214). The node verification logic 210 may send, in response to determination that the target node 131 is the allowed recipient of the base data 182, the base data 182 to the target node 131 for reception within the cryptographically-secure processing zone 150 (216).

Referring now to FIG. 2B while continuing to refer to FIG. 1, zone processing logic 220 is shown. The zone processing logic 220 may execute on circuitry such as node circuitry present on one or more processing nodes 130, e.g., on the first processing node (target node) 131. In some implementations, the zone processing logic 220 may execute the operations associated with receiving and processing of the base data 182 to generate the derivative data 184.

The zone processing logic 220 may receive base data 182 from at least the second node 132 within the network 190 of processing nodes 130 (222). Receiving the base data 182 may be at a cryptographically-secure processing zone 150 at the first processing node 131 within the network 190.

The zone processing logic 220 may then cause generation of a provenance token 174 indicating receipt of the base data 182 from the at least second node 132 (224). The zone processing logic 220 may generate and record the provenance tokens 174 in response to receipt of the base data 182. The provenance tokens 174 may identify from where the base data 182 was received. The provenance tokens 174 may be recorded on the distributed ledger 170. The provenance tokens 174 recorded on the ledger 170 may be used for establishing a provenance chain for base data 182. In the generation of the provenance token 174, the zone processing logic 220 may append the indication (e.g., the provenance indication) to a chain of indications (e.g., a chain of provenance indications) associated with data from multiple origins that received and processed data to generate the base data (225). In various implementations, recordation of provenance tokens on the ledger may be omitted. For example, the indication of the provenance chain (which may be present within the token itself or on another off-ledger location) and the indication of the base data may be relied on independently of transaction on tracking the ledger 170 (e.g., for proof-of-contribution) for the base data 182.

The zone processing logic 220 may process at least the base data 182 to generate derivative data 184 (226). Processing the base data 182 may be performed without transferring the base data 182 out of the cryptographically-secure processing zone 150 in an unencrypted form. Processing the base data 182 to generate derivative data 184 may include various operations. For example, processing the base data 182 may include preprocessing operations such as normalizing, filtering, and/or labeling the base data 182, extracting features from the base data 182, editing the base data 182, transformation or encoding of the base data 182, using the base data 182 to create new data based on the base data 182, and using the base data 182 to train a machine-learned model. In some implementations, processing the base data 182 may include: train, without transferring the base data 182 out of the cryptographically-secure processing zone 150 in an unencrypted form, at least a machine-learned model using the base data 182; and/or processing, via a machine-learned model and without transferring the base data 182 out of the cryptographically-secure processing zone 150 in an unencrypted form, at least the base data 182 to generate derivative data 184.

In some implementations, the base data 182 may include a machine-learned model, such as a neural network, a transformer model, and/or other trainable model. In some implementations, the derivative data 184 may include a machine-learned model, such as a neural network, a transformer model, and/or other trainable model. In some implementations, base data 182 may include an output from a machine-learned model, such as a neural network, a large language model, a transformer model, and/or other trainable model. In some implementations, the derivative data 184 may include an output from a machine-learned model, such as a neural network, a transformer model, and/or other trainable model. In some implementations, the base data 182 may include media content, such as movie, television, image, and/or written content. In some implementations, the derivative data 184 may include media content, such as movie, television, image, and/or written content. In some implementations, the base data 182 may include a machine-learned model for generation of a candidate substance for pharmaceutical use. In some implementations, the derivative data 184 may include a machine-learned model for generation of a candidate substance for pharmaceutical use. In some implementations, the base data 182 may include a machine-learned model for generation of a candidate substance for chemical use, such as chemical catalysts for specific classes of reactions, reagents, reactants, and/or other substances. In some implementations, the derivative data 184 may include a machine-learned model for generation of a candidate substance for chemical use, such as chemical catalysts for specific classes of reactions, reagents, reactants, and/or other substances. In some implementations, the base data 182 may include a machine-learned model for generation of a candidate substance for material use, such as nanomaterials, fabrics, construction materials, semiconductors, and/or other materials. In some implementations, the derivative data 184 may include a machine-learned model for generation of a candidate substance for material use, such as nanomaterials, fabrics, construction materials, semiconductors, and/or other materials.

In some implementations, the zone processing logic 220 may cause generation of an ownership token 176 indicating the ownership of the data (228). The zone processing logic 220 may generate and record the ownership tokens 176 in response to generation of the data (e.g., base data and/or the derivative data 184).

In some implementations, the zone processing logic 220 may generate the ownership tokens 176 before outputting the data from the nodes 130. The ownership tokens 176 may identify who has ownership of the data. The ownership tokens 176 may be recorded on the distributed ledger 170. The ownership tokens 176 recorded on the ledger 170 may be used for establishing an ownership chain associated with the data. In the generation of the ownership tokens 176, the zone processing logic 220 may append the ownership indication to a chain of ownership indications associated with data from multiple owners (229).

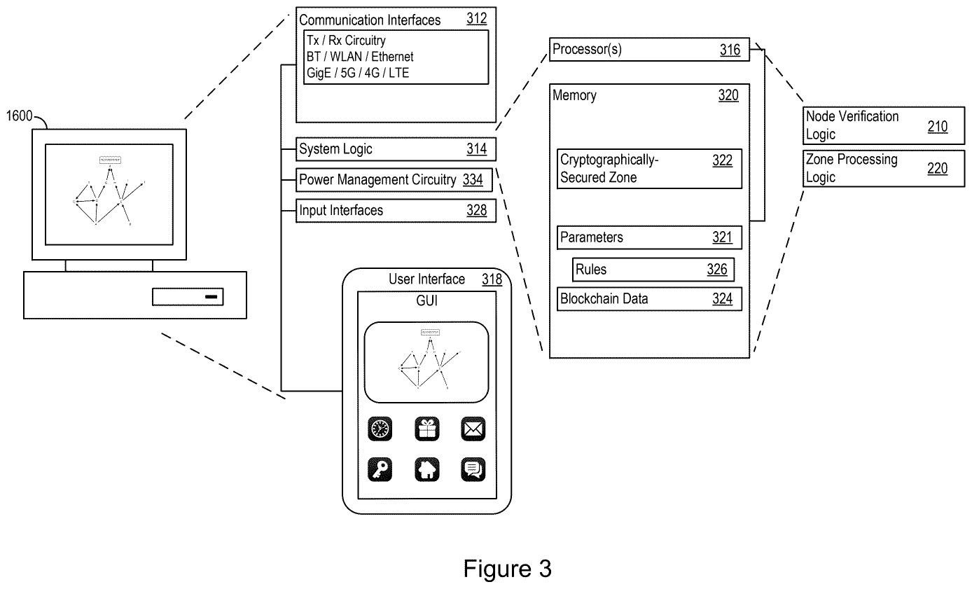

FIG. 3 shows an example execution system (ES) 300, which may provide a hardware environment for execution of the processing nodes for derivative data generation using cryptographically-secured zones. The ES 300 may include system logic 314 to support encryption and decryption; secure zone management; code validation; execution validation; and/or other code validation and/or data handling operations. The system logic 314 may include processors 316, memory 320, and/or other circuitry, which may be used to implement data management logic, data tracking logic, node verification logic 210, zone processing logic 220, ledger logic, which may be used to execute ledger updates and/or execute code.

The memory 320 may be used to implement the cryptographically-secured zone 322 and/or blockchain data 324 used in token tracking and/or management. The memory 320 may further store parameters 321, such as an encryption key values, generated random salt values, and/or other parameters that may facilitate sharing and manipulation of data. The memory may further store rules 326, which may support execution of zone setup code, implementation of blockchain consensus protocols, or other operations.

The memory 320 may further include applications and structures, for example, coded objects, templates, or one or more other data structures to support validation execution. The ES 300 may also include one or more communication interfaces 312, which may support wireless, e.g. Bluetooth, Wi-Fi, WLAN, cellular (5G, 4G, LTE/A), and/or wired, ethernet, Gigabit ethernet, optical networking protocols. Additionally, or alternatively, the communication interface 312 may support secure information exchanges, such as secure socket layer (SSL) or public-key encryption-based protocols for sending and receiving private data. The ES 300 may include power management circuitry 334 and one or more input interfaces 328.

The ES 300 may also include a user interface 318 that may include man-machine interfaces and/or graphical user interfaces (GUI). The GUI may be used to present options for validation confirmation, secured zone operations, execution profile displays, token management, ledger operations, and/or other options.

The ES 300 may be deployed on distributed hardware. For example, various functions of the ES 300 may be executed on cloud-based hardware, distributed static (and/or semi-static) network computing resources, and/or other distributed hardware systems. In various implementations, centralized and/or localized hardware systems may be used. For example, a unitary server or other non-distributed hardware system may perform role-execution logic operations.

The methods, devices, processing, and logic described above may be implemented in many different ways and in many different combinations of hardware and software. For example, all or parts of the implementations may be circuitry that includes an instruction processor, such as a Central Processing Unit (CPU), microcontroller, or a microprocessor; an Application Specific Integrated Circuit (ASIC), Programmable Logic Device (PLD), or Field Programmable Gate Array (FPGA); or circuitry that includes discrete logic or other circuit components, including analog circuit components, digital circuit components or both; or any combination thereof. The circuitry may include discrete interconnected hardware components and/or may be combined on a single integrated circuit die, distributed among multiple integrated circuit dies, or implemented in a Multiple Chip Module (MCM) of multiple integrated circuit dies in a common package, as examples.

The circuitry may further include or access instructions for execution by the circuitry. The instructions may be embodied as a signal and/or data stream and/or may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may particularly include a storage medium and instructions stored in or on the medium, and the instructions when executed by the circuitry in a device may cause the device to implement any of the processing described above or illustrated in the drawings.

The implementations may be distributed as circuitry, e.g., hardware, and/or a combination of hardware and software among multiple system components, such as among multiple processors and memories, optionally including multiple distributed processing systems. Parameters, databases, and other data structures may be separately stored and managed, may be incorporated into a single memory or database, may be logically and physically organized in many different ways, and may be implemented in many different ways, including as data structures such as linked lists, hash tables, arrays, records, objects, or implicit storage mechanisms. Programs may be parts (e.g., subroutines) of a single program, separate programs, distributed across several memories and processors, or implemented in many different ways, such as in a library, such as a shared library (e.g., a Dynamic Link Library (DLL)). The DLL, for example, may store instructions that perform any of the processing described above or illustrated in the drawings, when executed by the circuitry.

### Example Implementations

In an illustrative example scenario, a scheme for tracking data sharing within drug discovery is considered. Using the scheme one can know whether one's data was copied and used to train a further model which trained a further model which finally resulted in a blockbuster. By preserving IP through downstream shares, one can redistribute risk and thereby achieve a more liquid market with greater value and efficiency.

Additionally or alternatively to offering a single party exclusive rights to data, one could instead monetize with non-exclusive royalties at moderate upfront cost with upside potential for both “buyer” and “seller.”

An investor who purchases a basket of IPs not only gains user-friendly exposure to a diversified, otherwise inaccessible, early stage drug discovery pipeline but also helps bootstrap data upfront compute costs for data scientists who increase overall odds of producing a blockbuster.

A pipeline is a directed graph wherein each node hosts a machine learning model. For simplicity, we may refer to a node as a machine. Each pipeline edge from X to Y represents a stream of inferences and training between upstream machine X and downstream machine Y. Each inference on an upstream model trains its downstream counterpart.

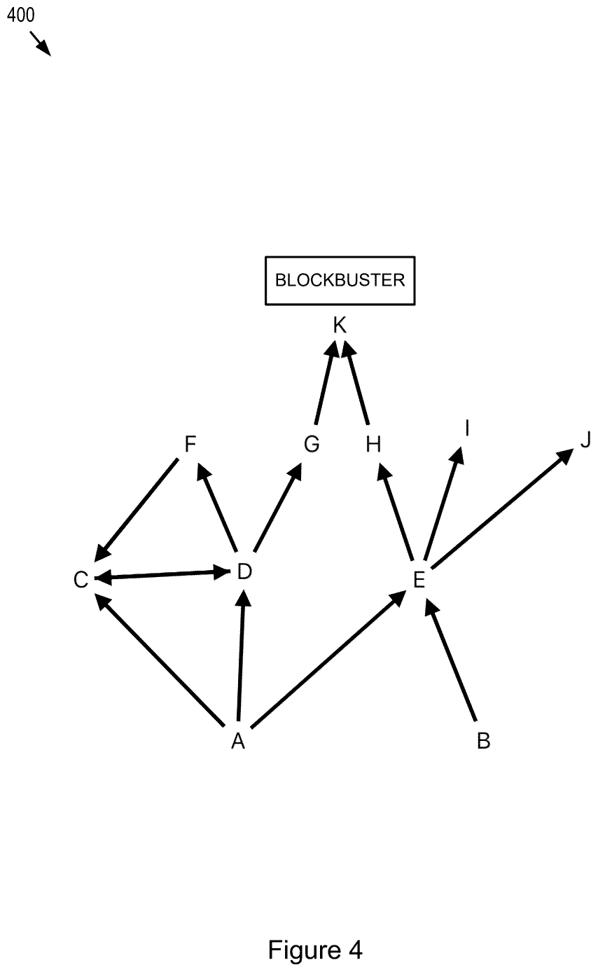

A machine without upstream neighbors is called a source, and a machine without downstream neighbors is called a sink. Sink nodes which meet a predefined success criteria are called blockbusters. The network must enforce that all nodes whose inferences contributed to a blockbuster receive prompt notification regarding their contribution. FIG. 4 shows an illustrative example collection 400 of relevant inferences for some blockbuster K derived from a collection of upstream machines, including source machines A and B. In this scenario all machines may receive notifications depending on the actual routing for training, except I and J.

Provenance. Each downstream action may be definitively recorded and reported to all upstream machines.

Decentralization. Each machine stores its own model behind its own firewall. There is no particular requirement for a central data repository or a trusted party for passing messages. However, various architectures described herein may readily incorporate centralized data management and storage.

Handcuffs. Machines are restricted to perform specific data processing and sharing. In particular, in this illustrative example, a machine cannot copy its own model.

In some cases, a centralized entity may take on risk by handling data storage and message passing. Such a server fail to send a notification or, perhaps even unbeknownst to others, suffer an attack compromising either data or messaging. A centralized entity may, in some cases, place both IP usage notifications and data at risk. The server itself also bears liability risk. A rogue machine who had nothing to do with the blockbuster in question could credibly accuse the server of unauthorized use of its model or failure to notify, even if the server behaved perfectly.

Non-uniformity of data and model formats can be addressed locally between adjacent machines with proper documentation.

We enforce the Provenance, Decentralization, and Handcuff requirements via use of a secure enclave.

Truebit Verify, which may operate in accord with transcript generation schemes discussed above, generates non-forgeable transcripts for API calls and computations. Notifications passed between machines take the form of Truebit tasks. Truebit creates a timestamped record of messages sent, even when the sender is offline. It also certifies the syntactical correctness of a message including sender signatures. Truebit also verifies the initial setup of the enclave described in the next paragraph. In order to prevent model leakage through inferences. all messages between machines are encrypted Truebit transcripts, with data optionally protected through homomorphic encryption or other means, so that only the recipient machine can read them. Anyone viewing such a transcript can read the sender and recipient machines in plaintext, but the message content itself is encrypted with the recipient machine's key.

Similar to some mobile secure enclave implementations that allow apps to verify identity credentials but does not permit them to download or modify those credentials, the secure enclave restricts machine operations and access to its model. The four permitted operations are inference from an upstream neighbor machine, training to a downstream neighbor machine, and messaging to all upstream enclaves. All communications between machines takes the form of a Truebit task. Prior to making an inference from an upstream model, the machine must provably notify all known upstream machines of this activity through their respective enclaves.

Each machine stores its own model within an enclave within its own information technology infrastructure so that each machine is provably responsible for its own data and not for the data of any other machine.

By inspection of the previous two paragraphs on enclaves and breaches, the network satisfies Decentralization, and provenance is guaranteed by a combinations transcript usage and enclaves. The enclaves provide Handcuffs in such a way that Truebit can propagate errors.

There are a number of ways to incentivize network participants, ranging from recursive incentive schemes which weight rewards more heavily towards machines which are closer to the blockbuster to paying greater rewards for machines which perform the most training steps leading to the blockbuster.

Other industries have recently expressed needs for similar technology. The Biden administration recently announced $100 million in funding to facilitate the use of AI technologies in sustainable semiconductor materials. Within the aerospace industry, DARPA has solicited AI ideas to win dogfights. The AI in Nanotechnology Market Size is valued at USD 9.30 billion in 2023 and is predicted to reach USD 40.14 billion by the year 2031 including nanoelectronics and optoelectronics behind nanomedicine and drug delivery. Other related areas include microscopy, chemical modeling, and nanocomputing. The $20 million MELLODY project previously took a federated learning approach to pharmaceutical collaboration. More broadly, virtually any system in which derivative data is generated from base data inputs may be used with the architecture and techniques described herein, including this illustrative example.

Various implementations have been specifically described. However, many other implementations are also possible.

Table 1 shows various examples.

TABLE 1
Examples

1. A system including:
a first processing node within a network of processing nodes, the first
processing node including:
a memory including a cryptographically-secure processing zone; and
zone processing circuitry configured to:
receive, at the cryptographically-secure processing zone, base data
from at least a second node within the network of processing nodes;
cause generation of a provenance token indicating receipt of the base
data from the at least second node; and
process, without transfer of the base data out of the cryptographically-
secure processing zone in an unencrypted form, at least the base data
to generate derivative data.
2. The system of example 1 and/or any other example in this table, where,
in processing the at least the base data, the zone processing circuitry is
further configured to:
train, without transfer of the base data out of the cryptographically-
secure processing zone in the unencrypted form, at least a machine-
learned model using the base data.
3. The system of example 1 and/or any other example in this table, where,
in processing the at least the base data, the zone processing circuitry is
further configured to:
process, via a machine-learned model and without transfer of the base
data out of the cryptographically-secure processing zone in the
unencrypted form, at least the base data to generate derivative data.
4. The system of example 1 and/or any other example in this table, where
the cryptographically-secure processing zone is configured to bar
unencrypted read operations of content.
5. The system of example 1 and/or any other example in this table, where
the cryptographically-secure processing zone includes a secure enclave.
6. The system of example 1 and/or any other example in this table, where
the base data is further associated with an ownership token indicating
ownership of the base data by one or more entities, the ownership token
different from the provenance token.
7. The system of example 1 and/or any other example in this table, where
the base data and/or the derivative data includes a machine-learned model.
8. The system of example 1 and/or any other example in this table, where
the base data and/or the derivative data includes an output from a machine-
learned model.
9. The system of example 1 and/or any other example in this table, where
the base data and/or the derivative data includes media content.
10. The system of example 1 and/or any other example in this table, where
the cryptographically-secure processing zone includes a memory space
protected via data-encryption.
11. The system of example 10 and/or any other example in this table, where
the memory space protected via data-encryption includes a specific rule for
compliant allowed inputs to and allowed outputs from the memory space.
12. The system of example 11 and/or any other example in this table, where
the specific rule for compliant allowed inputs to and allowed outputs from the
memory space include preventing access to an unencrypted form of a
machine-learned model regardless of whether the machine-learned model
includes the base data or the derivative data.
13. The system of example 11 and/or any other example in this table, where
the specific rule for compliant allowed inputs to and allowed outputs from the
memory space include allowing access to an unencrypted form of the
derivative data including a machine-learned model output.
14. The system of example 11 and/or any other example in this table, where
the specific rule for compliant allowed inputs to and allowed outputs from the
memory space include preventing access to an unencrypted form of the base
data including a machine-learned model output.
15. The system of example 1 and/or any other example in this table, where
the base data and/or the derivative data includes a machine-learned model
for generation of a candidate substance for pharmaceutical use.
16. The system of example 1 and/or any other example in this table, where
the base data and/or the derivative data includes a machine-learned model
for generation of a candidate substance for chemical use.
17. The system of example 1 and/or any other example in this table, where
the base data and/or the derivative data includes a machine-learned model
for generation of a candidate substance for material use.
18. A method including:
accessing a distributed ledger to determine an execution transcript, the
execution transcript indicating that a target node executed a defined protocol
without deviation from the defined protocol, execution of the defined protocol
establishing a cryptographically-secure processing zone on the target node;
based on the execution transcript, determining that the target node is an
allowed recipient for base data within the cryptographically-secure
processing zone on the target node;
responsive to determination that the target node is the allowed recipient,
sending the base data to the target node for reception within the
cryptographically-secure processing zone.
19. A method including:
receiving, at a cryptographically-secure processing zone at a first processing
node within a network of processing nodes, base data from at least a second
node within the network of processing nodes;
causing generation of a provenance token indicating receipt of the base data
from the at least the second node; and
processing, without transfer of the base data out of the cryptographically-
secure processing zone in an unencrypted form, at least the base data to
generate derivative data.
20. The method of example 19 and/or any other example in this table,
where the generation of the provenance token includes appending an
indication to a chain of indications associated with data from multiple origins
that received and processed the data to generate the base data.
1P. A system including:
a first processing node within a network of processing nodes, the first
processing node including:
a memory including a cryptographically-secure processing zone the
cryptographically-secure processing zone; and
zone processing circuitry configured to:
receive, at the cryptographically-secure processing zone, the base data
from at least a second node within the network of processing nodes;
cause generation of a provenance token indicating receipt of the base
data from the at least second node; and
process, without transfer of the base data out of the cryptographically-
secure processing zone in an unencrypted form, at least the base data
to generate derivative data.
2P. A system including:
a first processing node within a network of processing nodes, the first
processing node including:
a memory including a cryptographically-secure processing zone the
cryptographically-secure processing zone; and
zone processing circuitry configured to:
receive, at the cryptographically-secure processing zone, the base data
from at least a second node within the network of processing nodes;
cause generation of a provenance token indicating receipt of the base
data from the at least second node;
train, without transfer of the base data out of the cryptographically-
secure processing zone in an unencrypted form, at least a machine-
learned model using the base data.
3P. A system including:
a first processing node within a network of processing nodes, the first
processing node including:
a memory including a cryptographically-secure processing zone the
cryptographically-secure processing zone configured to bar unencrypted read
operations of the content; and
zone processing circuitry configured to:
receive, at the cryptographically-secure processing zone, the base data
from at least a second node within the network of processing nodes;
cause generation of a provenance token indicating receipt of the base
data from the at least second node;
process, via a machine-learned model and without transfer of the base
data out of the cryptographically-secure processing zone in an
unencrypted form, at least the base data to generate derivative data.
4P. A method including:
accessing a distributed ledger to determine an execution transcript, the
execution transcript indicating that a target node executed a defined protocol
without deviation from the defined protocol, execution of the defined protocol
establishing a cryptographically-secure processing zone on the target node;
based on the execution transcript, determining that the target node is an
allowed recipient for base data within the cryptographically-secure
processing zone on the target node;
responsive to determination that the target node is an allowed recipient,
sending the base data to the target node for reception within the
cryptographically-secure processing zone.
5P. A method including:
receiving, at a cryptographically-secure processing zone at a first processing
node within a network of processing nodes, base data from at least a second
node within the network of processing nodes;
causing generation of a provenance token indicating receipt of the base data
from the at least second node; and
processing, without transfer of the base data out of the cryptographically-
secure processing zone in an unencrypted form, at least the base data to
generate derivative data.
6P. The method and/or system of any of the examples in this table, where
the cryptographically-secure processing zone includes a secure enclave.
7P. The method and/or system of any of the examples in this table, where
the base data is further associated with an ownership token indicating
ownership of the base data by one or more entities, the ownership token
different from the provenance token.
8P. The method and/or system of any of the examples in this table, where
generation of the provenance token includes appending the indication to a
chain of indications associated with data from multiple origins received and
processed to generate the base data.
9P. The method and/or system of any of the examples in this table, where
the derivative data includes a machine-learned model, such as a neural
network, a transformer model, and/or other trainable model.
10P. The method and/or system of any of the examples in this table, where
the base data includes a machine-learned model, such as a neural network,
a transformer model, and/or other trainable model.
11P. The method and/or system of any of the examples in this table, where
the derivative data includes an output machine-learned model, such as a
neural network, a transformer model, and/or other trainable model.
12P. The method and/or system of any of the examples in this table, where
the base data includes an output from machine-learned model, such as a
neural network, a large language model, a transformer model, and/or other
trainable model.
13P. The method and/or system of any of the examples in this table, where
the base data and/or derivative includes media content, such as movie,
television, image, and/or written content.
14P. The method and/or system of any of the examples in this table, where
cryptographically-secure processing zone includes a memory space
protected via data-encryption.
15P. The method and/or system of any of the examples in this table, where
the memory space protected via data-encryption includes specific rules for
compliant allowed inputs to and allowed outputs from the memory space.
16P. The method and/or system of any of the examples in this table, where
the specific rules for compliant allowed inputs to and allowed outputs from
the memory space include preventing access to unencrypted forms of
machine-learned models regardless of whether the machine-learned models
include base data or derivative data.
17P. The method and/or system of any of the examples in this table, where
the specific rules for compliant allowed inputs to and allowed outputs from
the memory space include allowing access to unencrypted forms of
derivative data including machine-learned models outputs.
18P. The method and/or system of any of the examples in this table, where
the specific rules for compliant allowed inputs to and allowed outputs from
the memory space include preventing access to unencrypted forms of base
data including machine-learned models outputs.
19P. The method and/or system of any of the examples in this table, where
the base data and/or derivative include machine-learned models for
generation of candidate substances for pharmaceutical use.
20P. The method and/or system of any of the examples in this table, where
the base data and/or derivative include machine-learned models for
generation of candidate substances for chemical use, such as chemical
catalysts for specific classes of reactions, reagents, reactants, and/or other
substances.
21P. The method and/or system of any of the examples in this table, where
the base data and/or derivative include machine-learned models for
generation of candidate substances for materials use, such as
nanomaterials, fabrics, construction materials, semiconductors, and/or other
materials.
22P. A method including implementing any feature and/or group of features in
this disclosure.
23P. A system including circuitry configured to implement any feature and/or
group of features in this disclosure.
24P. Media including machine-readable instructions configured to cause a
machine to implement any feature and/or group of features in this disclosure,
where:
optionally, the media is other than a transitory signal and/or the media is non-
transitory; and/or
optionally, the machine-readable instructions are executable by processing
circuitry.

Headings and/or subheadings used herein are intended only to aid the reader with understanding described implementations. The invention is defined by the claims.

What is claimed is:

1. A system including:
a first processing node within a network of processing nodes, the first processing node including:
a memory including a cryptographically-secure processing zone; and
zone processing circuitry configured to:
receive, at the cryptographically-secure processing zone, base data from at least a second node within the network of processing nodes;
cause generation of a provenance token indicating receipt of the base data from the at least second node; and
process, without transfer of the base data out of the cryptographically-secure processing zone in an unencrypted form, at least the base data to generate derivative data.

2. The system of claim 1, where, in processing the at least the base data, the zone processing circuitry is further configured to:
train, without transfer of the base data out of the cryptographically-secure processing zone in the unencrypted form, at least a machine-learned model using the base data.

3. The system of claim 1, where, in processing the at least the base data, the zone processing circuitry is further configured to:
process, via a machine-learned model and without transfer of the base data out of the cryptographically-secure processing zone in the unencrypted form, at least the base data to generate derivative data.

4. The system of claim 1, where the cryptographically-secure processing zone is configured to bar unencrypted read operations of content.

5. The system of claim 1, where the cryptographically-secure processing zone includes a secure enclave.

6. The system of claim 1, where the base data is further associated with an ownership token indicating ownership of the base data by one or more entities, the ownership token different from the provenance token.

7. The system of claim 1, where the base data and/or the derivative data includes a machine-learned model.

8. The system of claim 1, where the base data and/or the derivative data includes an output from a machine-learned model.

9. The system of claim 1, where the base data and/or the derivative data includes media content.

10. The system of claim 1, where the cryptographically-secure processing zone includes a memory space protected via data-encryption.

11. The system of claim 10, where the memory space protected via data-encryption includes a specific rule for compliant allowed inputs to and allowed outputs from the memory space.

12. The system of claim 11, where the specific rule for compliant allowed inputs to and allowed outputs from the memory space include preventing access to an unencrypted form of a machine-learned model regardless of whether the machine-learned model includes the base data or the derivative data.

13. The system of claim 11, where the specific rule for compliant allowed inputs to and allowed outputs from the memory space include allowing access to an unencrypted form of the derivative data including a machine-learned model output.

14. The system of claim 11, where the specific rule for compliant allowed inputs to and allowed outputs from the memory space include preventing access to an unencrypted form of the base data including a machine-learned model output.

15. The system of claim 1, where the base data and/or the derivative data includes a machine-learned model for generation of a candidate substance for pharmaceutical use.

16. The system of claim 1, where the base data and/or the derivative data includes a machine-learned model for generation of a candidate substance for chemical use.

17. The system of claim 1, where the base data and/or the derivative data includes a machine-learned model for generation of a candidate substance for material use.

18. A method including:
accessing a distributed ledger to determine an execution transcript, the execution transcript indicating that a target node executed a defined protocol without deviation from the defined protocol, execution of the defined protocol establishing a cryptographically-secure processing zone on the target node;
based on the execution transcript, determining that the target node is an allowed recipient for base data within the cryptographically-secure processing zone on the target node; and
responsive to determination that the target node is the allowed recipient, sending the base data to the target node for reception within the cryptographically-secure processing zone.

19. A method including:
receiving, at a cryptographically-secure processing zone at a first processing node within a network of processing nodes, base data from at least a second node within the network of processing nodes;
causing generation of a provenance token indicating receipt of the base data from the at least the second node; and
processing, without transfer of the base data out of the cryptographically-secure processing zone in an unencrypted form, at least the base data to generate derivative data.

20. The method of claim 19, where the generation of the provenance token includes appending an indication to a chain of indications associated with data from multiple origins that received and processed the data to generate the base data.
